(19) United States
(12) Patent Application Publication
(10) Pub. No.: US 2014/0152612 A1
(43) Pub. Date: Jun. 5, 2014

(54) TOUCH SYSTEM AND METHOD OF DETERMINING LOW-NOISE FREQUENCY OF THE SAME

(71) Applicant: SAMSUNG ELECTRONICS CO., LTD., SUWON-SI (KR)

(72) Inventors: KWANG-HO CHOI, GANGBUK-GU (KR); SANG-WOO KIM, HWASEONG-SI (KR); CHANG-JU LEE, SUWON-SI (KR)

(73) Assignee: SAMSUNG ELECTRONICS CO., LTD., SUWON-SI (KR)

(21) Appl. No.: 14/061,439

(22) Filed: Oct. 23, 2013

(30) Foreign Application Priority Data
Dec. 3, 2012 (KR) 10-2012-0138932

(51) Int. Cl. G06F 3/044

(52) U.S. Cl. CPC G06F 3/044
USPC 345/174

(57) ABSTRACT

A touch system includes a touch sensor panel and a touch-screen control circuit. The touch-screen control circuit analyzes a spectrum of noise included in touch data and determines a low-noise driving frequency while the touch screen control circuit senses the touch data input to the touch sensor panel by selectively using prototype digital filters respectively having different filter frequencies from each other.

### CROSS-REFERENCE TO RELATED APPLICATION

This application claims priority under 35 U.S.C. §119 to Korean Patent Application No. 10-2012-0138932 filed on Dec. 3, 2012, the disclosure of which is incorporated by reference herein in its entirety.

### TECHNICAL FIELD

Embodiments of the inventive concept relate to a touch system, and particularly, to a capacitive multi-touch system and a method of determining a low-noise frequency of the capacitive multi-touch system.

### DISCUSSION OF RELATED ART

A touch screen system may be used as an input device. The touch screen system may include a touch sensor panel having a touch-sensitive surface and a display device disposed under the touch sensor panel.

Noise, together with touch data, may be input to the touch screen system through the touch sensor panel upon touching the touch sensor panel, thus causing a malfunction of the touch screen system.

### SUMMARY

In accordance with an exemplary embodiment of the inventive concept, a touch system, e.g., a capacitive multi-touch system, includes a touch sensor panel and a touch-screen control circuit.

The touch-screen control circuit analyzes a spectrum of noise included in touch data and determines a low-noise driving frequency while the touch screen control circuit senses the touch data input to the touch sensor panel by selectively using a plurality of prototype digital filters respectively having different filter frequencies from each other.

In an exemplary embodiment of the inventive concept, the touch-screen control circuit may analyze the spectrum of the noise based on center frequencies of the digital filters while shifting the filter frequencies of the digital filters.

In an exemplary embodiment of the inventive concept, the touch-screen control circuit may perform filtering by sequentially selecting the digital filters.

In an exemplary embodiment of the inventive concept, the capacitive multi-touch system may obtain the spectrum of the noise included in the touch data substantially concurrently with sensing the touch data.

In an exemplary embodiment of the inventive concept, the touch-screen control circuit may include an analog front-end unit, a digital signal processor (DSP), a driving pulse generator, and a processor.

The analog front-end unit converts a first signal received from the touch sensor panel into a second signal. The analog front-end unit converts the second signal into digital input data. The first signal includes a charge-type signal, and the second signal includes a voltage-type signal. The digital signal processor (DSP) converts the digital input data into digital output data. The digital signal processor (DSP) determines the low-noise driving frequency by analyzing the spectrum of the noise included in the touch data. The driving pulse generator generates a driving pulse in response to the low-noise driving frequency and provides the driving pulse to the touch sensor panel. The processor controls a display device based on the digital output data.

In an exemplary embodiment of the inventive concept, the analog front-end unit may include a first converter, e.g., a C-V (Charge-to-Voltage) converter, and a second converter, e.g., an analog-to-digital (A/D) converter.

The C-V converter converts the first signal received from the touch sensor panel into the second signal. The A/D converter converts the second signal into the digital input data.

In an exemplary embodiment of the inventive concept, the analog front-end unit may further include an anti-aliasing filter. The anti-aliasing filter eliminates anti-aliasing noise from the second signal and provides the second signal to the A/D converter.

In an exemplary embodiment of the inventive concept, the digital signal processor (DSP) may include a touch data processing unit and a noise spectrum analyzer. The touch data processing unit converts the digital input data into the digital output data. The noise spectrum analyzer determines the low-noise driving frequency by analyzing the spectrum of the noise included in the touch data.

In an exemplary embodiment of the inventive concept, the noise spectrum analyzer may include the plurality of digital filters.

In an exemplary embodiment of the inventive concept, the noise spectrum analyzer may further include a summing circuit, a first selecting circuit, and a second selecting circuit. The summing circuit receives the digital input data from the analog front-end unit through a plurality of sensing channels and sums the digital input data. The first selecting circuit selectively transfers an output signal of the summing circuit to the plurality of digital filters. The second selecting circuit selectively transfers output signals of the plurality of digital filters to an output terminal of the noise spectrum analyzer.

In accordance with an exemplary embodiment of the inventive concept, a method of determining a low-noise driving frequency of a touch system, e.g., a capacitive multi-touch system, includes sensing touch data input to a touch sensor panel. A spectrum of a noise included in the touch data is analyzed by selectively using digital filters respectively having different filter frequencies while sensing the touch data. A low-noise driving frequency of the capacitive multi-touch system is determined.

In an exemplary embodiment of the inventive concept, the spectrum of the noise is analyzed based on center frequencies of the digital filters while shifting filter frequencies of the digital filters.

In an exemplary embodiment of the inventive concept, a driving pulse is generated in response to the low-noise driving frequency. The driving pulse is provided to the touch sensor panel.

According to an exemplary embodiment of the inventive concept, a touch system comprises a panel and a controller. The panel is configured to generate an analog signal by sensing a touch. The controller is configured to convert the analog signal into a digital signal. The controller is configured to obtain a frequency spectrum of a noise signal included in the digital signal by a plurality of filters respectively having different center frequencies from each other. The controller is configured to determine a lowest frequency of the obtained frequency spectrum as a driving frequency.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a block diagram illustrating a capacitive multi-touch system, in accordance with an exemplary embodiment of the inventive concept;

FIG. 2 is a flowchart illustrating a method of determining a low-noise driving frequency of a capacitive multi-touch system, in accordance with an exemplary embodiment of the inventive concept;

FIG. 3 is a diagram illustrating a touch sensor panel included in the capacitive multi-touch system of FIG. 1, according to an exemplary embodiment of the inventive concept;

FIG. 4 is a circuit diagram illustrating a noise spectrum analyzer included in the capacitive multi-touch system of FIG. 1, according to an exemplary embodiment of the inventive concept;

FIG. 5 is a diagram illustrating filter frequencies of digital filters included in the noise spectrum analyzer of FIG. 4, according to an exemplary embodiment of the inventive concept;

FIG. 6 is a diagram illustrating an output of the noise spectrum analyzer of FIG. 4, according to an exemplary embodiment of the inventive concept;

FIGS. 7 and 8 are diagrams illustrating a structure of a digital filter, in accordance with an exemplary embodiment of the inventive concept;

FIG. 9 is a diagram illustrating a process of shifting to a low-noise driving frequency, according to an exemplary embodiment of the inventive concept;

FIG. 10 is a block diagram illustrating a mobile phone including a capacitive multi-touch system, in accordance with an exemplary embodiment of the inventive concept; and

FIG. 11 is a block diagram illustrating a digital audio/video player including a capacitive multi-touch system, in accordance with an exemplary embodiment of the inventive concept.

### DETAILED DESCRIPTION OF THE EMBODIMENTS

Various embodiments will now be described in more detail with reference to the accompanying drawings. These inventive concept may, however, be embodied in different ways

It will be understood that when an element or layer is referred to as being “on,” “connected to,” or “coupled to” another element or layer, it can be directly on, connected or coupled to the other element or layer or intervening elements or layers may be present. Like numerals may refer to like or similar elements throughout the specification and the drawings.

As used herein, the singular forms “a,” “an,” and “the” are intended to include the plural forms as well, unless the context clearly indicates otherwise.

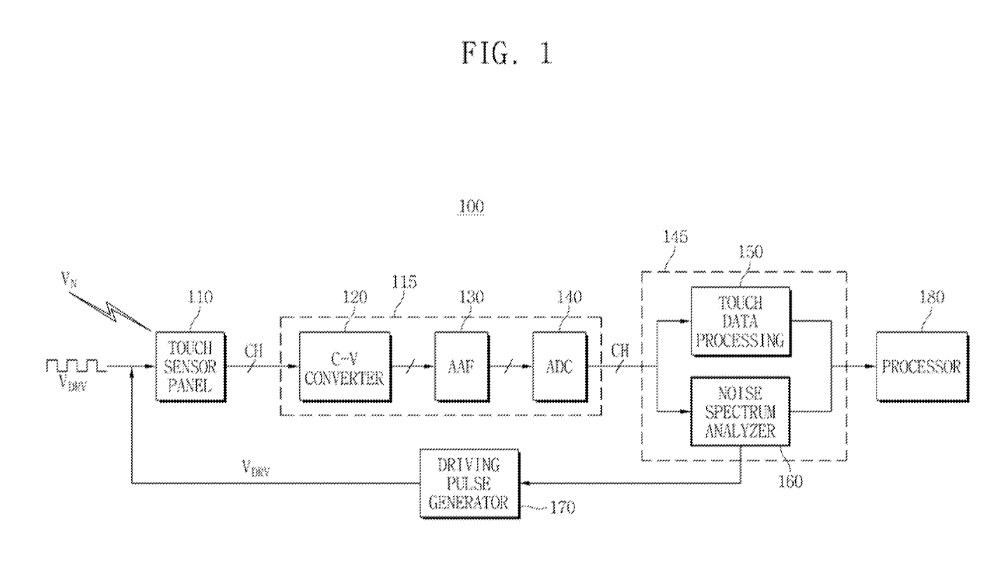

FIG. 1 is a block diagram illustrating a capacitive multi-touch system 100, in accordance with an exemplary embodiment of the inventive concept.

Referring to FIG. 1, the capacitive multi-touch system 100 may include a touch sensor panel 110 and a touch-screen control circuit. The touch-screen control circuit may include an analog front-end unit 115, a digital signal processor (DSP) 145, a driving pulse generator 170 and a processor 180.

The touch-screen control circuit analyzes a spectrum of noise included in touch data and determines a low-noise driving frequency while sensing the touch data input to the touch sensor panel 110 by selectively using prototype digital filters having different filter frequencies.

The touch sensor panel 110 operates in response to a driving voltage VDRV and touch data, and the touch sensor panel 110 generates an electric charge signal corresponding to a touch input. Noise VN may be included when the touch data is input to the touch sensor panel 110. The front-end circuit 115 converts a first signal of an electric charge type into a second signal of a voltage type, and performs analog-to-digital conversion on the second signal, generating digital input data. The DSP 145 performs digital signal processing on the digital input data, generating digital output data. The DSP 145 analyzes a noise spectrum of noise included in the touch data, generating a low-noise driving frequency. The driving pulse generator 170 generates a driving pulse VDRV in response to the low-noise driving frequency and provides the driving pulse VDRV to the touch sensor panel 110. The processor 180 controls a display device based on the digital output data. The processor 180 may move an object such as a cursor or a pointer in response to an output of the DSP 145. A plurality of channels CH may be disposed between the touch sensor panel 110 and the digital signal processor 145.

The front-end circuit 115 may include a capacitance-voltage (C-V) converter 120 that converts the charge signal into a plurality of first voltage signals corresponding to the charge signal, an anti-aliasing filter 130 that eliminates noise included in the first voltage signals and generate second voltage signals, and an analog-to-digital converter 140 that converts the second voltage signals into a plurality of digital signals corresponding to the second voltage signals.

The digital signal processor 145 may include a touch data processing unit 150 and a noise spectrum analyzer 160. The touch data processing unit performs digital signal processing on digital input data, generating digital output data. The noise spectrum analyzer 160 analyzes the spectrum of the noise included in the touch data, determining the low-noise driving frequency.

The touch screen control circuit may analyze a noise spectrum based on a center frequency while shifting filter frequencies of digital filters. Further, the touch screen control circuit may include a plurality of digital filters respectively having different center frequencies, and the touch screen control circuit may sequentially select the digital filters and may perform filtering by the selected digital filters. The capacitive multi-touch system 100 may obtain the spectrum of the noise included in the touch data substantially concurrently with sensing the touch data.

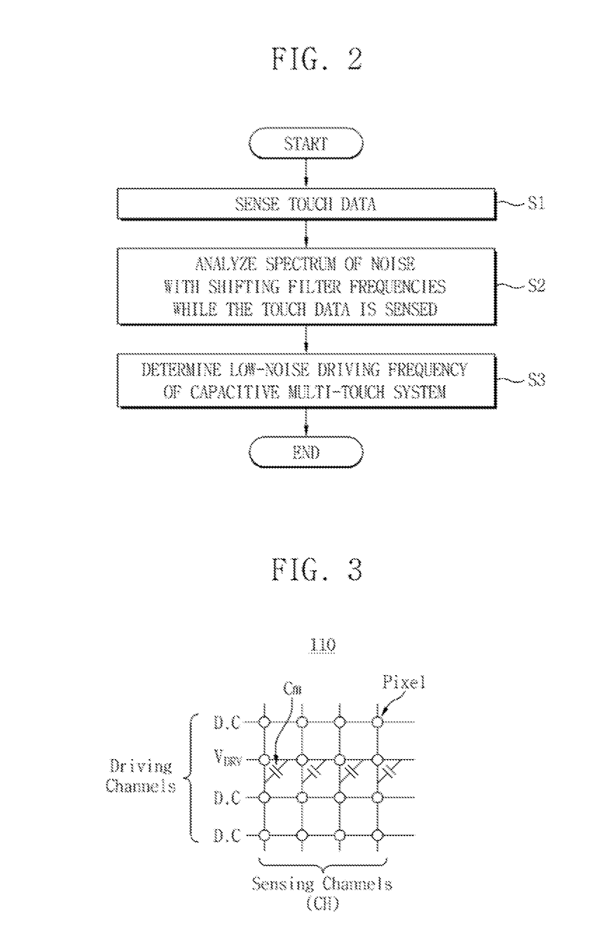

FIG. 2 is a flowchart illustrating a method of determining a low-noise driving frequency of a capacitive multi-touch system, in accordance with an exemplary embodiment of the inventive concept.

Referring to FIGS. 1 and 2, according to the method of determining a low-noise driving frequency of a capacitive multi-touch system, touch data input to the touch sensor panel 110 is sensed (S1). A spectrum of noise included in the touch data is analyzed while the touch screen control circuit senses the touch data input to the touch sensor panel 110 selectively using prototype digital filters respectively having different filter frequencies from each other (S2). A low-noise driving frequency of a capacitive multi-touch system is determined (S3).

Analyzing the spectrum of the noise included in the touch data may include analyzing a noise spectrum based on center frequencies of the digital filters while shifting filter frequencies of digital filters.

The method of determining a low-noise driving frequency of a capacitive multi-touch system may further include generating a driving pulse in response to the low-noise driving frequencies and providing the driving pulse to the touch sensor panel 110.

FIG. 3 is a diagram illustrating a touch sensor panel included in the capacitive multi-touch system of FIG. 1, according to an exemplary embodiment of the inventive concept.

Referring to FIG. 3, the touch sensor panel 110 includes pixels that are located where driving channels and sensing channels CH cross. A mutual capacitance Cm may occur between its corresponding driving channel and its corresponding sensing channel CH. A driving voltage VDRV may be applied to one of the driving channels, and a D.C. voltage may be applied to the rest of the driving channels.

FIG. 4 is a circuit diagram illustrating a noise spectrum analyzer 160 included in the capacitive multi-touch system of FIG. 1, according to an exemplary embodiment of the inventive concept.

Referring to FIG. 4, the noise spectrum analyzer 160 may include a plurality of digital filters 164 (F_{—}0, F_{—}1, . . . , and F_(N−1)) respectively having different center frequencies, a summing circuit 162, a first selecting circuit 163 and a second selecting circuit 165. The summing circuit 162 receives digital input data from a plurality of sensing channels CH1 to CHn and sums the received digital input data. The first selecting circuit 163 selectively transfers a signal output from the summing circuit 162 to the plurality of digital filters F_{—}0, F_{—}1, . . . , and F_(N−1). The second selecting circuit 165 selectively transfers signals y₀[n] to y_{N-1}[n] respectively output from the plurality of digital filters F_{—}0, F_{—}1, . . . , and F_(N−1) to an output terminal of the noise spectrum analyzer 160.

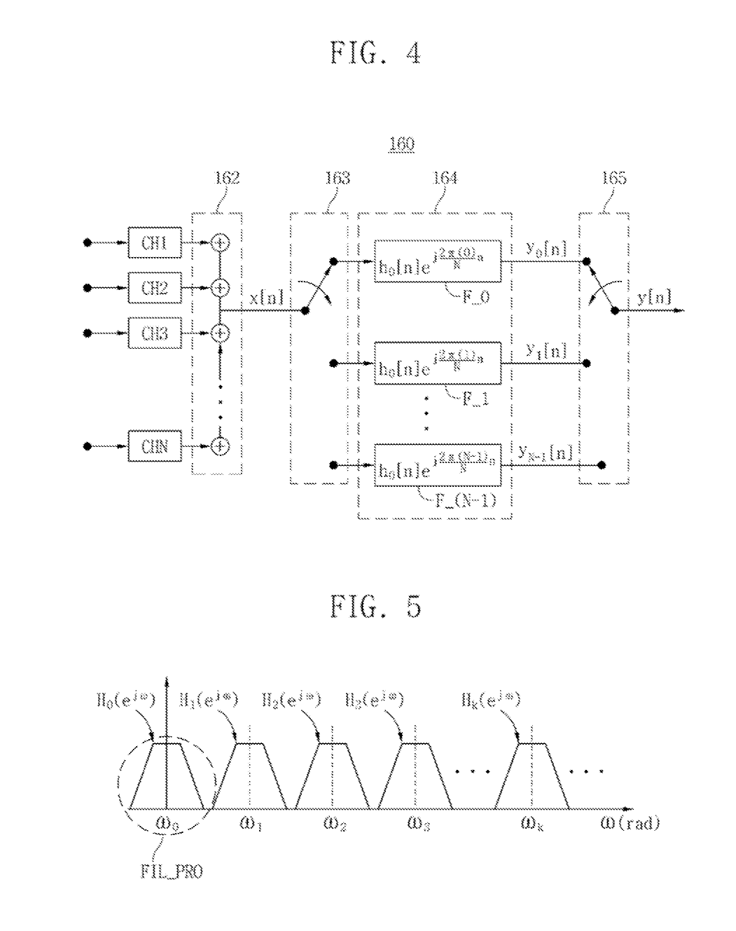

FIG. 5 is a diagram illustrating filter frequencies of digital filters included in the noise spectrum analyzer 160 of FIG. 4, according to an exemplary embodiment of the inventive concept.

Referring to FIG. 5, when a center frequency of a prototype digital filter FIL_PRO is ωo, other digital filters may have center frequencies at ω₁ ω₂, ω₃, . . . , and ωₖ, respectively. The digital filters respectively may have impulse responses shown in respective blocks of the digital filters F_{—}0, F_{—}1, . . . , and F_(N−1) of FIG. 4. As shown in FIG. 5, H₀(e^{iω}), H₁(e^{iω}), H₂(e^{iω}), H₃(e^{iω}), . . . , and Hₖ(e^{iω}) respectively denote Fourier-transformed values of the impulse responses shown in the respective digital filter blocks F_{—}0, F_{—}1, . . . , and F_(N−1) of FIG. 4.

As illustrated in FIGS. 4 and 5, the capacitive multi-touch system 100 according to an exemplary embodiment of the inventive concept may analyze a noise spectrum based on center frequencies of digital filters while shifting filter frequencies of the digital filters.

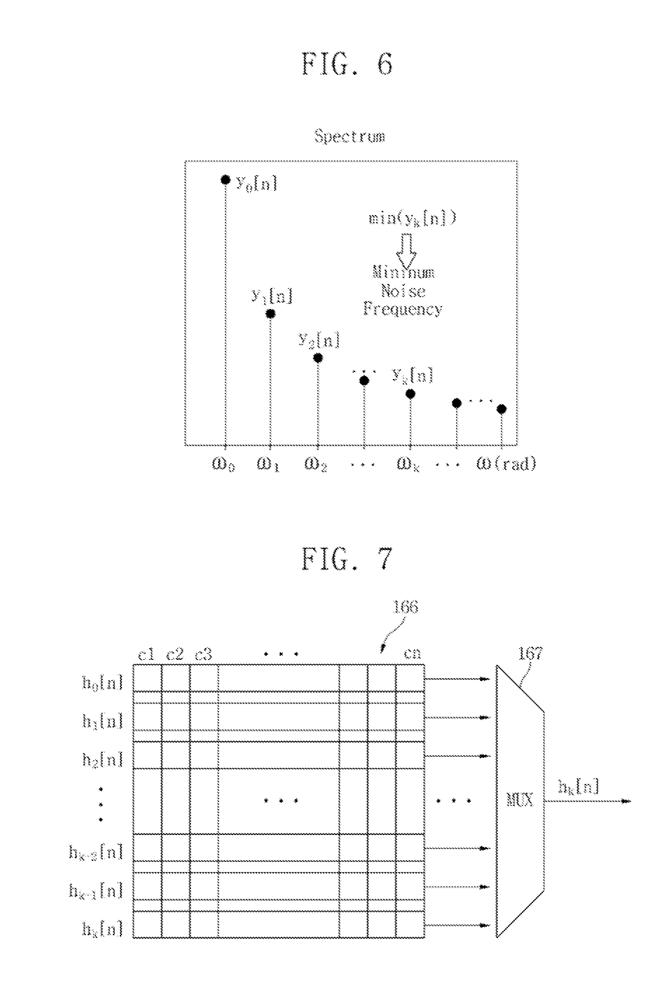

FIG. 6 is a diagram illustrating an output of the noise spectrum analyzer of FIG. 4, according to an exemplary embodiment of the inventive concept.

As shown in FIG. 6, output values of the digital filters F_{—}0, F_{—}1, . . . , and F₁₃ (N−1), that are noise values, are shown when center frequencies of digital filters are ω₁ ω₂, ω₃, and ωₖ. The noise spectrum analyzer 160 may determine a low-noise driving frequency using the noise spectrum shown in FIG. 6.

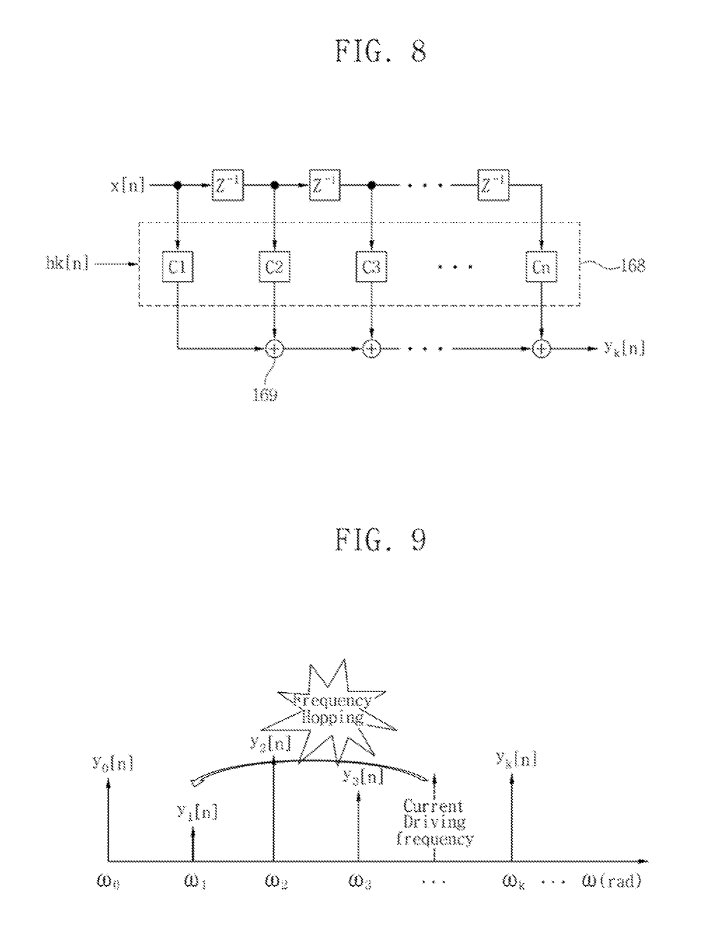

FIGS. 7 and 8 are diagrams illustrating a structure of a digital filter, in accordance with an exemplary embodiment of the inventive concept.

As shown in FIG. 7, filter coefficient values c1 to cn and impulse responses H₀[n] to Hₖ[n] may be stored in a switching filter memory 166, and the impulse responses H₀[n] to Hₖ[n] may be output through a multiplexer 167.

Referring to FIG. 8, a filter output yk[n] may be determined by multiplying a filter input x[n] by a value obtained by a combination of a impulse response Hₖ[n], a filter coefficient 168, a delay Z⁻¹ and a summing circuit 169.

FIG. 9 is a diagram illustrating a process of shifting to a low-noise driving frequency.

Referring to FIG. 9, a driving frequency having minimum noise can be obtained by sequentially selecting and filtering the digital filters 164 (F_{—}0, F_{—}1, . . . , and F_(N−1)) respectively having center frequencies of ω₁ ω₂, ω₃, . . . , and ωₖ shown in FIG. 4.

FIG. 10 is a block diagram illustrating a mobile phone 1000 including a capacitive multi-touch system, in accordance with an exemplary embodiment of the inventive concept.

Referring to FIG. 10, the mobile phone 1000 may include a touch sensor panel 1100, a display device 1200 and a touch-screen control circuit 1300. The display device 1200 may be disposed under the touch sensor panel 1100. The touch-screen control circuit 1300 may have substantially the same structure as the touch-screen control circuit described above in connection with FIG. 1. The touch-screen control circuit 1300 may analyze a spectrum of noise included in touch data and may determine a low-noise driving frequency while the touch screen control circuit 1300 senses the touch data input to the touch sensor panel 1100. Further, touch-screen control circuit 1300 may analyze a noise spectrum based on center frequencies of digital filters while shifting filter frequencies of the digital filters.

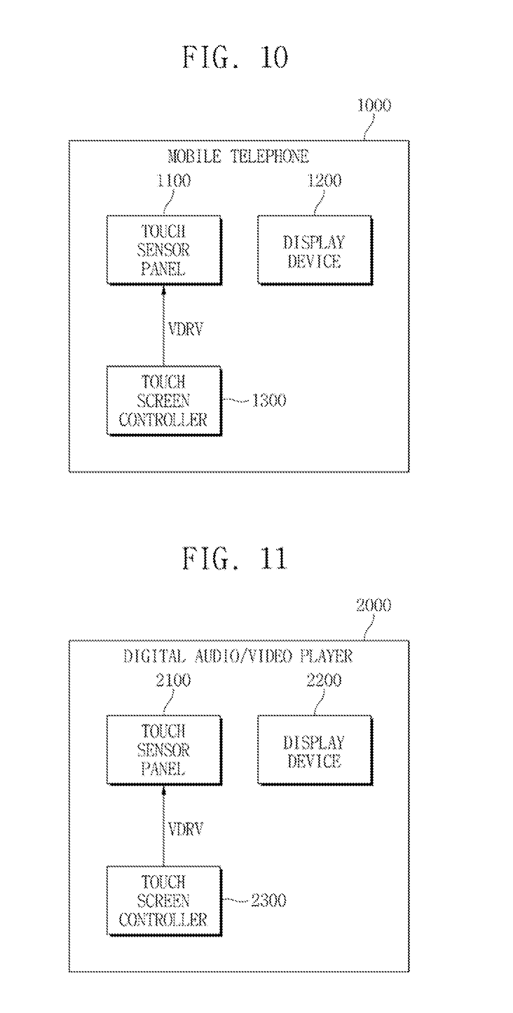

FIG. 11 is a block diagram illustrating a digital audio/video player 2000 including a capacitive multi-touch system, in accordance with an exemplary embodiment of the inventive concept.

Referring to FIG. 11, the digital audio/video player 2000 may include a touch sensor panel 2100, a display device 2200 and a touch-screen control circuit 2300. The display device 2200 may be disposed under the touch sensor panel 2100. The touch-screen control circuit 2300 may have substantially the same structure as the touch-screen control circuit described above in connection with FIG. 1. The touch-screen control circuit 2300 may analyze a spectrum of a noise included in touch data to determine a low-noise driving frequency while the touch screen control circuit 2300 senses the touch data input to the touch sensor panel 2100. Further, touch-screen control circuit 2300 may analyze a noise spectrum based on a center frequency of a digital filter while shifting filter frequencies of the digital filter.

Exemplary embodiments of the inventive concept may be applied to a display system that includes a capacitive multi-touch system.

The capacitive multi-touch system according to an exemplary embodiment of the inventive concept may determine a low noise deriving frequency by analyzing a noise spectrum of noise included in touch data by selectively using prototype digital filters respectively having different frequencies from each other, while the capacitive multi-touch system senses the touch data input to a touch sensor panel. The capacitive multi-touch system may analyze a noise spectrum based on center frequencies of the prototype digital filters while shifting filter frequencies of the prototype digital filters. Accordingly, the capacitive multi-touch system may prevent errors from occurring in the capacitive multi-touch system.

The foregoing is illustrative of embodiments and is not to be construed as limiting thereof Although a few exemplary embodiments have been described, those skilled in the art will readily appreciate that many modifications may be made thereto.

What is claimed is:

1. A touch system, comprising:
a touch sensor panel; and
a touch-screen control circuit configured to analyze a spectrum of noise included in touch data and configured to determine a low-noise driving frequency while the touch screen control circuit senses the touch data input to the touch sensor panel by selectively using a plurality of digital filters respectively having different filter frequencies from each other.

2. The touch system according to claim 1, wherein the touch-screen control circuit is configured to analyze the spectrum of the noise based on center frequencies of the digital filters while shifting the filter frequencies of the digital filters.

3. The touch system according to claim 1, wherein the touch-screen control circuit is configured to perform filtering by sequentially selecting the digital filters.

4. The touch system according to claim 1, wherein the touch system is configured to obtain the spectrum of the noise included in the touch data substantially concurrently with sensing the touch data.

5. The touch system according to claim 1, wherein the touch-screen control circuit comprises:
an analog front-end unit configured to convert a first signal received from the touch sensor panel into a second signal and configured to convert the second signal into digital input data, wherein the first signal includes a charge-type signal, and the second signal includes a voltage-type signal;
a digital signal processor (DSP) configured to convert the digital input data into digital output data and configured to determining the low-noise driving frequency by analyzing the spectrum of the noise included in the touch data;
a driving pulse generator configured to generate a driving pulse in response to the low-noise driving frequency and configured to provide the driving pulse to the touch sensor panel; and
a processor configured to control a display device based on the digital output data.

6. The touch system according to claim 5, wherein the analog front-end unit comprises:
a first converter configured to convert the first signal received from the touch sensor panel into the second signal; and
a second converter configured to convert the second signal to the digital input data.

7. The touch system according to claim 6, wherein the analog front-end unit further comprises:
an anti-aliasing filter configured to eliminate anti-aliasing noise from the second signal and configured to provide the second signal to the second converter.

8. The touch system according to claim 5, wherein the digital signal processor (DSP) comprises:
a touch data processing unit configured to convert the digital input data into the digital output data; and
a noise spectrum analyzer configured to determine the low-noise driving frequency by analyzing the spectrum of the noise included in the touch data.

9. The touch system according to claim 8, wherein the noise spectrum analyzer includes the plurality of digital filters.

10. The touch system according to claim 9, wherein the noise spectrum analyzer further comprises:
a summing circuit configured to receive the digital input data from the analog front-end unit through a plurality of sensing channels and configured to sum the digital input data;
a first selecting circuit configured to selectively transfer an output signal of the summing circuit to the plurality of digital filters; and
a second selecting circuit configured to selectively transfer output signals of the plurality of digital filters to an output terminal of the noise spectrum analyzer .

11. A phone, comprising:
the touch system of claim 1; and
a display device configured to operate in response to an output of the touch system.

12. A digital audio/video player, comprising:
the touch system of claim 1; and
a display device configured to operate in response to an output of the touch system.

13. A method of determining a low-noise driving frequency of a touch system, the method comprising:
sensing touch data input to a touch sensor panel;
analyzing a spectrum of noise included in the touch data while sensing the touch data by selectively using digital filters respectively having different filter frequencies; and
determining a low-noise driving frequency of the touch system.

14. The method of claim 13, wherein the spectrum of the noise is analyzed based on center frequencies of the digital filters while shifting filter frequencies of the digital filters.

15. The method of claim 13, further comprising:
generating a driving pulse in response to the low-noise driving frequency; and
providing the driving pulse to the touch sensor panel.

16. A touch system, comprising:
a panel configured to generate an analog signal by sensing a touch; and
a controller configured to convert the analog signal into a digital signal, configured to obtain a frequency spectrum of a noise signal included in the digital signal by a plurality of filters respectively having different center frequencies from each other, and configured to determine a lowest frequency of the obtained frequency spectrum as a driving frequency.
